(19) United States
(12) Patent Application Publication
(10) Pub. No.: US 2003/0203694 A1
(43) Pub. Date: Oct. 30, 2003

(54) Coform filter media having increased particle loading capacity

(75) Inventors: Ganesh Chandra Deka, Duluth, GA (US); Ronald C. Cox, Smyrna, GA (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/133,599

(22) Filed: Apr. 26, 2002

(51) Int. Cl. B32B 5/26

(52) U.S. Cl. 442/359; 442/381; 442/382; 442/400; 442/401; 442/403; 442/412; 442/416; 264/168

(57) ABSTRACT

Disclosed is a filter medium having at least a first layer containing a stabilized matrix of thermoplastic filaments and at least one secondary material; and a second layer having a stabilized matrix of thermoplastic filaments and optionally of at least one secondary material. Each of the layer of the filter medium has a different compositional ratio of the components to result in a gradient structure. The compositional gradient for the layers of the coform results in a filter having improved capacity, which extends the life of the filter medium, as compared to a filter without the compositional gradient. The present invention also provides a method of removing particles from a fluid containing particles. The method of the present invention includes contacting the fluid containing particles with the filter medium of having the two layers described above in a manner such that the fluid containing particles is passed through the first layer of the filter medium before the second layer.

### FIELD OF THE INVENTION

The present invention is related to a filter medium, more particularly, the present invention is related to a nonwoven web highly suitable as a fluid filter media.

### BACKGROUND OF THE INVENTION

Various particulate filtering media have been formed from diverse materials, such as glass fibers, asbestos fibers, synthetic polymer fibers, e.g., polyolefins, polyamides, polyesters and the like, and natural fibers, such as wood pulp and the like. Desirably, a particulate filter medium should possess high particulate filtration efficiency, but should also possess high filtered fluid (e.g., gas or liquid) permeability and a high particle holding capacity. However, these performance attributes tend to be inversely related. For example, in some instances, increasing the particulate filtration efficiency of a filter media may tend to increase the pressure-differential at the filter media between the filtered fluid. Similarly, increasing the efficiency of a filter may tend to reduce the capacity of the filter.

As is known in the filtration art, filtration efficiency is improved by improving the ability of the filter media to mechanically entrap contaminates. In some instances, the filter media's ability to mechanically entrap contaminates, such as particulates in a fluid, is improved by increasing the loft or thickness of the filter media without increasing the density of the filter media. However, increasing the filter media's thickness has several disadvantages. In some instances, existing filter receiving structures may not be large enough to receive such thickened filters. In other instances, and particularly in those instances when the filter media is formed from a coform of wood pulp and polymer fibers, such increased thickness is generally achieved by incorporating increased quantities of the coform materials. Increasing the quantities of these materials not only results in increased material costs and shipping costs, but also reduces the filter material's fluid throughput by increasing the pressure differential across the filter media. Further, increasing the thickness of the filter may or may not increase the particle capacity holding of the resulting filter.

Therefore, there exists a need for a filter media, and particularly for filter media formed from a coform of wood pulp and polymer fibers, and methods of making the same which provides improved filter capacity, without sacrificing filtration efficiency, over conventional filter media formed from similar materials.

### SUMMARY OF THE INVENTION

The present invention provides a filter medium having at least a first layer containing a stabilized matrix of thermoplastic filaments and at least one secondary material; and a second layer having a stabilized matrix of thermoplastic filaments and optionally of at least one secondary material. If the second layer contains the secondary material, then the weight percentage of the secondary material in the first layer, based on the total weight of the thermoplastic filaments and the secondary material in the first layer, is different from the weight percentage of secondary material in the second layer, based on the total weight of the thermoplastic filaments and the secondary material in the second layer.

In the present invention, it has been discovered that the compositional gradient for the layer of the coform results in a filter having improved particle holding capacity, which extends the life of the filter medium, as compared to a filter without the compositional gradient.

In other aspects of the present invention, the thermoplastic fiber are meltblown fibers. Further the thermoplastic fibers are present in an amount from about 5% to about 85% by weight in the first layer and from about 10% to about 100% by weight in the second layer. The secondary material is present in an amount of about 15% to about 95% by weight in the first layer and about 0% by weight to about 90% by weight in the second layer. Exemplary secondary materials include absorbent fibers, absorbent particles, non-absorbent fibers, non-absorbent particles and mixtures thereof.

In a further aspect of the present invention, the additional layers can be included in the filter medium to further improve the filter efficiency, strength of the filter medium.

The present invention also provides a method of removing particles from a fluid containing particles. The method of the present invention includes contacting the fluid containing particles with the filter medium of having the two layers described above in a manner such that the fluid containing particles is passed through the first layer of the filter medium before the second layer.

### BRIEF DESCRIPTIONS OF THE DRAWINGS

FIG. 1 illustrates the structure of the filter medium of the present invention.

FIG. 2 illustrates an additional structure of the filter medium of the present invention.

FIG. 3 illustrates a process which may be used to prepare coform nonwoven filter media of the present invention.

FIGS. 4A-C are micrographs of the structure of the coform nonwoven filter medium of the present invention after use.

FIGS. 5A-C are micrographs of the structure of a comparative coform nonwoven filter medium after use.

### DEFINITIONS

As used herein, the term “comprising” is inclusive or open-ended and does not exclude additional unrecited elements, compositional components, or method steps.

As used herein, the term “fiber” includes both staple fibers, i.e., fibers which have a defined length between about 2 and about 20 mm, fibers longer than staple fiber but are not continuous, and continuous fibers, which are sometimes called “substantially continuous filaments” or simply “filaments”. The method in which the fiber is prepared will determine if the fiber is a staple fiber or a continuous filament.

As used herein, the term “nonwoven web” means a web having a structure of individual fibers or threads which are interlaid, but not in an identifiable manner as in a knitted web. Nonwoven webs have been formed from many processes, such as, for example, meltblowing processes, spunbonding processes, air-laying processes, coforming processes and bonded carded web processes. The basis weight of nonwoven webs is usually expressed in ounces of material per square yard (osy) or grams per square meter (gsm) and the fiber diameters useful are usually expressed in microns, or in the case of staple fibers, denier. It is noted that to convert from osy to gsm, multiply osy by 33.91.

As used herein, the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, which is hereby incorporated by reference in its entirety. Meltblown fibers are microfibers, which may be continuous or discontinuous, and are generally smaller than 10 microns in average diameter, and are generally tacky when deposited onto a collecting surface.

As used herein, the term “coform nonwoven web” or “coform material” means composite materials comprising a mixture or stabilized matrix of thermoplastic filaments and at least one additional material, usually called the “second material” or the “secondary material”. As an example, coform materials may be made by a process in which at least one meltblown die head is arranged near a chute through which the second material is added to the web while it is forming. The second material may be, for example, an absorbent material such as fibrous organic materials such as woody and non-wood cellulosic fibers, including regenerated fibers such as cotton, rayon, recycled paper, pulp fluff; superabsorbent materials such as superabsorbent particles and fibers; inorganic absorbent materials and treated polymeric staple fibers and the like; or a non-absorbent material, such as non-absorbent staple fibers or non-absorbent particles. Exemplary coform materials are disclosed in commonly assigned U.S. Pat. No. 5,350,624 to Georger et al.; U.S. Pat. No. 4,100,324 to Anderson et al.; and U.S. Pat. No. 4,818,464 to Lau et al.; the entire contents of each is hereby incorporated by reference.

As used herein the term “spunbond fibers” refers to small diameter fibers of molecularly oriented polymeric material. Spunbond fibers may be formed by extruding molten thermoplastic material as filaments from a plurality of fine, usually circular capillaries of a spinneret with the diameter of the extruded filaments then being rapidly reduced as in, for example, U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,542,615 to Dobo et al, and U.S. Pat. No. 5,382,400 to Pike et al. Spunbond fibers are generally not tacky when they are deposited onto a collecting surface and are generally continuous. Spunbond fibers are often about 10 microns or greater in diameter. However, fine fiber spunbond webs (having and average fiber diameter less than about 10 microns) may be achieved by various methods including, but not limited to, those described in commonly assigned U.S. Pat. No. 6,200,669 to Marmon et al. and U.S. Pat. No. 5,759,926 to Pike et al., each is hereby incorporated by reference in its entirety.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “multicomponent fibers” refers to fibers or filaments which have been formed from at least two polymers extruded from separate extruders but spun together to form one fiber. Multicomponent fibers are also sometimes referred to as “conjugate” or “bicomponent” fibers or filaments. The term “bicomponent” means that there are two polymeric components making up the fibers. The polymers are usually different from each other, although conjugate fibers may be prepared from the same polymer, if the polymer in each component is different from one another in some physical property, such as, for example, melting point or the softening point. In all cases, the polymers are arranged in substantially constantly positioned distinct zones across the cross-section of the multicomponent fibers or filaments and extend continuously along the length of the multicomponent fibers or filaments. The configuration of such a multicomponent fiber may be, for example, a sheath/core arrangement, wherein one polymer is surrounded by another, a side-by-side arrangement, a pie arrangement or an “islands-in-the-sea” arrangement. Multicomponent fibers are taught in U.S. Pat. No. 5,108,820 to Kaneko et al.; U.S. Pat. No. 5,336,552 to Strack et al.; and U.S. Pat. No. 5,382,400 to Pike et al.; the entire content of each is incorporated herein by reference. For two component fibers or filaments, the polymers may be present in ratios of 75/25, 50/50, 25/75 or any other desired ratios.

As used herein, the term “multiconstituent fibers” refers to fibers which have been formed from at least two polymers extruded from the same extruder as a blend or mixture. Multiconstituent fibers do not have the various polymercomponents arranged in relatively constantly positioned distinct zones across the cross-sectional area of the fiber and the various polymers are usually not continuous along the entire length of the fiber, instead usually forming fibrils or protofibrils which start and end at random.

### DETAILED DESCRIPTION

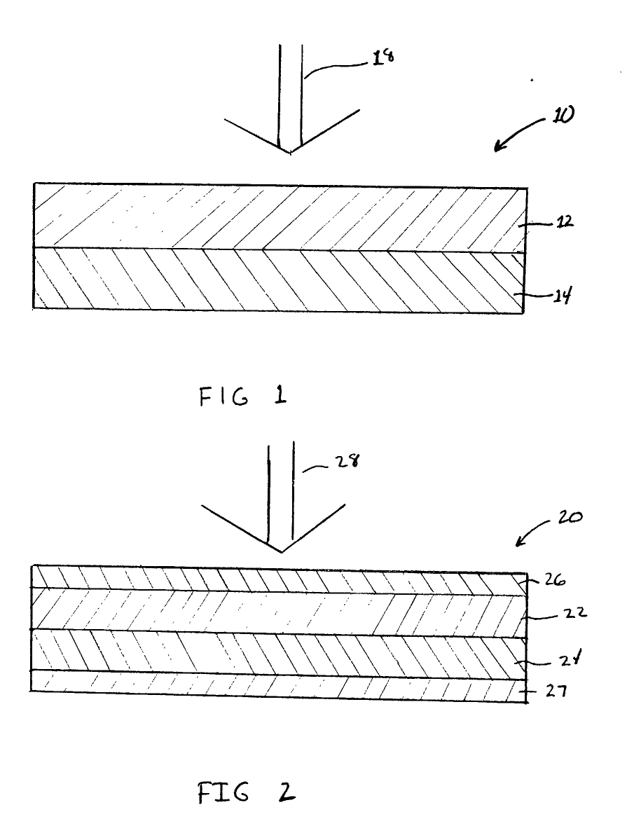

As is illustrated in FIG. 1, the present invention provides a filter medium 10 having at least a first layer 12 containing a stabilized matrix of thermoplastic filaments and at least one secondary material; and a second layer 14 having a stabilized matrix of thermoplastic filaments and optionally of at least one secondary material. The second 14 layer is adjacent to the first layer and the weight percentage of the secondary material in the first layer, based on the total weight of the thermoplastic filaments and the secondary material in the first layer, is different from the weight percentage of secondary material in the second layer, based on the total weight of the thermoplastic filaments and the secondary material in the second layer.

The thermoplastic filaments making-up the first and second layers can be prepared by many known processes, such as the spunbond process, spun fibers cut to staple length, meltblown fibers and the like. Preferably, the thermoplastic filaments are meltblown filaments prepared from thermoplastic polymers. Suitable thermoplastic polymers useful in the present invention include polyolefins, polyesters, polyamides, polycarbonates, polyurethanes, polyvinylchloride, polytetrafluoroethylene, polystyrene, polyethylene terephathalate, biodegradable polymers such as polylactic acid and copolymers and blends thereof. Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene, and blends thereof; polybutylene, e.g., poly(1-butene) and poly(2-butene); polypentene, e.g., poly(1-pentene) and poly(2-pentene); poly(3-methyl-1-pentene); poly(4-methyl 1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include polyethylene terephthalate, polytrimethylene terephthalate, polybutylene terephthalate, polytetramethylene terephthalate, polycyclohexylene-1,4-dimethylene terephthalate, and isophthalate copolymers thereof, as well as blends thereof.

Many polyolefins are available for fiber production, for example pdyethylenes such as Dow Chemical's ASPUN 6811A linear low-density polyethylene, 2553 LLDPE and 25355 and 12350 high density polyethylene are such suitable polymers. The polyethylenes have melt flow rates in g/10 min. at 190° F. and a load of 2.16 kg, of about 26, 40, 25 and 12, respectively. Fiber forming polypropylenes include, for example, Basell's PF-015 polypropylene. Many other polyolefins are commercially available and generally can be used in the present invention. The particularly preferred polyolefins are polypropylene and polyethylene.

Examples of polyamides and their methods of synthesis may be found in “Polymer Resins” by Don E. Floyd (Library of Congress Catalog number 66-20811, Reinhold Publishing, N.Y., 1966). Particularly commercially useful polyamides are nylon 6, nylon-6,6, nylon-11 and nylon-12. These polyamides are available from a number of sources such as Custom Resins, Nyltech, among others. In addition, a compatible tackifying resin may be added to the extrudable compositions described above to provide tackified materials that autogenously bond or which require heat for bonding. Any tackifier resin can be used which is compatible with the polymers and can withstand the high processing (e.g., extrusion) temperatures. If the polymer is blended with processing aids such as, for example, polyolefins or extending oils, the tackifier resin should also be compatible with those processing aids. Generally, hydrogenated hydrocarbon resins are preferred tackifying resins, because of their better temperature stability. REGALREZ® and ARKON® P series tackifiers are examples of hydrogenated hydrocarbon resins. ZONATAC® 501 Lite is an example of a terpene hydrocarbon. REGALREZ® hydrocarbon resins are available from Hercules Incorporated. ARKON®P series resins are available from Arakawa Chemical (USA) Incorporated. The tackifying resins such as disclosed in U.S. Pat. No. 4,787,699, hereby incorporated by reference, are suitable. Other tackifying resins which are compatible with the other components of the composition and can withstand the high processing temperatures, can also be used.

The meltblown filaments may be monocomponent fibers, meaning fibers prepared from one polymer component, multiconstituent fibers, or multicomponent fibers. The multicomponent filaments may have either of an A/B or A/B/A side-by-side configuration, or a sheath-core configuration, wherein one polymer component surrounds another polymer component.

The secondary material of the nonwoven web of the present invention may be an absorbent material, such as absorbent fibers or absorbent particles, or non-absorbent materials, such as non-absorbent fibers or non-absorbent particles. Secondary fibers may generally be fibers such as polyester fibers, polyamide fibers, cellulosic derived fibers such as, for example, rayon fibers and wood pulp fibers, multi-component fibers such as, for example, sheath-core multi-component fibers, natural fibers such as silk fibers, wool fibers or cotton fibers or electrically conductive fibers or blends of two or more of such secondary fibers. Other types of secondary fibers such as, for example, polyethylene fibers and polypropylene fibers, as well as blends of two or more of other types of secondary fibers may be utilized. The secondary fibers may be microfibers or the secondary fibers may be macrofibers having an average diameter of from about 300 microns to about 1,000 microns.

The selection of the second material will determine the properties of the resulting filter media. For example, the absorbency of the filter media can be improved by using an absorbent material as the second material. In the case where absorbency is not necessary or not desired, non-absorbent material may be selected as the secondary material.

The absorbent materials useful in the present invention include absorbent fibers, absorbent particles and mixtures of absorbent fibers and absorbent particles. Examples of the absorbent material include, but are not limited to, fibrous organic materials such as woody or non-woody pulp from cotton, rayon, recycled paper, pulp fluff, inorganic absorbent materials, treated polymeric staple fibers and so forth. Desirably, although not required, the absorbent material is preferably a cellulosic material such as pulp.

The pulp fibers may be any high-average fiber length pulp, low-average fiber length pulp, or mixtures of the same. Preferred pulp fibers include cellulose fibers. The term “high average fiber length pulp” refers to pulp that contains a relatively small amount of short fibers and non-fiber particles. High fiber length pulps typically have an average fiber length greater than about 1.5 mm, preferably about 1.5-6 mm. Sources generally include non-secondary (virgin) fibers as well as secondary fiber pulp which has been screened. The term “low average fiber length pulp” refers to pulp that contains a significant amount of short fibers and non-fiber particles. Low average fiber length pulps typically have an average fiber length less than about 1.5 mm.

Examples of high average fiber length wood pulps include those available from Georgia-Pacific under the trade designations Golden Isles 4821 and 4824. The low average fiber length pulps may include certain virgin hardwood pulp and secondary (i.e., recycled) fiber pulp from sources including newsprint, reclaimed paperboard, and office waste. Mixtures of high average fiber length and low average fiber length pulps may contain a predominance of low average fiber length pulps. For example, mixtures may contain more than about 50% by weight low-average fiber length pulp and less than about 50% by weight high-average fiber length pulp. One exemplary mixture contains about 75% by weight low-average fiber length pulp and about 25% by weight high-average fiber length pulp.

The pulp fibers may be unrefined or may be beaten to various degrees of refinement. Crosslinking agents and/or hydrating agents may also be added to the pulp mixture. Debonding agents may be added to reduce the degree of hydrogen bonding if a very open or loose nonwoven pulp fiber web is desired. Exemplary debonding agents are available from the Quaker Oats Chemical Company, Conshohocken, Pa., under the trade designation Quaker 2028 and Berocell 509ha made by Eka Nobel, Inc. Marietta, Ga. The addition of certain debonding agents in the amount of, for example, 1-4% by weight of the pulp fibers, may reduce the measured static and dynamic coefficients of friction and improve the abrasion resistance of the thermoplastic meltblown polymer filaments. The debonding agents act as lubricants or friction reducers. Debonded pulp fibers are commercially available from Weyerhaeuser Corp. under the designation NB 405.

In addition, non-absorbent secondary materials can be incorporated into the dual texture coform nonwoven web, depending on the end use of the dual texture coform nonwoven web. For example, in end uses where absorbency is not an issue, non-absorbent secondary materials may be used. These non-absorbent materials include nonabsorbent fibers and nonabsorbent particles. Examples of the fibers include, for example, staple fibers of untreated thermoplastic polymers, such as polyolefins and the like. Examples of nonabsorbent particles include activated charcoal, sodium bicarbonate, alumina and the like. The nonabsorbent material can be used alone or in combination with the absorbent material.

It is possible to use a mixture of secondary materials in the filter media of the present invention. That is, a mixture of absorbent and non-absorbent materials may be used. Likewise, a mixture of particles and fibers maybe used as the secondary material.

In the practice of the present invention, it is necessary to have a different composition in each of the layers. Depending on factors such as the diameter of the thermoplastic fibers and the diameter of the secondary material, length of the thermoplastic fibers and length of the secondary material, when fibers, the composition of the layers are adjusted accordingly. Generally, it is preferred that the second layer have a greater density that the first layer. This will generally result in a filter which has smaller pores in the second layer, as compared for the first. This can be accomplished by many methods, such as increasing the percentage of the smaller diameter fiber in the second layer, as compared to the first layer. For example, if the thermoplastic fibers have a smaller fiber diameter than the secondary material, then the weight percentage of the thermoplastic filaments in the second layer should be higher than the weight percentage of the thermoplastic filaments in the first layer. By adjusting the percentage of thermoplastic filaments in each layer such that the second layer has a higher percentage of the thermoplastic filaments, a gradient structure is formed in the filter media. In a similar manner, if the secondary material has a smaller diameter than the thermoplastic filaments, then the weight percentage of the secondary material in the second layer should be higher than the weight percentage of the secondary material in the first layer. It has been discovered that this gradient structure results in a filter having an increased capacity, without a substantial reduction in the efficiency of the filter medium.

Another factor which may impact the percentage of the thermoplastic filaments and secondary material in the filter media include fiber length of the secondary material. When relatively short fibers are used as the secondary material, for example fibers having a length less than about 3 mm, it is desirable to have the shorter fiber in a greater weight percentage in the second layer than the weight percentage of the secondary fibers in the first layer. This is because the shorter fibers tend to more densely pack in each of the layers than the longer fibers.

In the filter media of the present invention, the first layer has a ratio of first layer contains from about 5% to about 85% by weight of the thermoplastic filaments and from about 15% by weight to about 95% by weight of the secondary material. In addition, the second layer comprises from about 10% to about 100% by weight thermoplastic filaments and from about 0% by weight to about 90% by weight of the secondary material. More preferably, the first layer comprises from about 20% to about 50% by weight of the thermoplastic filaments and from about 50% by weight to about 80% by weight of the secondary material and a second layer comprises from about 50% to about 80% by weight thermoplastic filaments and from about 20% by weight to about 50% by weight of the secondary material.

The filter media of the present invention may have a basis weight ranging between about 0.5 osy (17 gsm) to about 14 osy (475 gsm). Preferably, the basis weight of the filter media is in the range of about 1 osy (34 gsm) to about 8 osy (272 gsm). Most preferably, the basis weight is in the range of about 1.5 osy (51 gsm) to about 6 osy (204 gsm).

It is noted that the basis weight to the filter is adjusted to the particular application in which the filter is being used, taking into account the desired filtration efficiency, strength requirements, particle holding capacity and the size of the particles to be removed from the fluid. For example, if the filter is used to capture larger particles, it is desirable to have lower basis weight since these particles are easier to trap. If the filter is used in to capture smaller particles, it is desirable to have a higher basis weight since the particles are harder to capture and the higher basis weights typically are thicker, making it more difficult for the small particles to pass through the filter. In a similar fashion, higher basis weight filter medium tend to have a higher filtration efficiency and tend to be stronger than lower basis weight materials.

In using the filter medium of the present invention, the particle containing fluid should be passed through the filter in a direction from the first layer towards the second layer. The direction of fluid flow is shown by arrow 18 in FIG. 1. This allows the filter medium to have an acceptable efficiency and a high capacity, which results in a filter having an extended life. However, the filter could be used such that the fluid may flow through the filter medium in the direction from the second layer towards the first layer. If an increase in the efficiency is desired, then it may be desirable to flow the fluid through the filter in a direction from the second layer towards the first layer. That is, flowing the particle containing fluid through the filter in a direction opposite arrow 18.

In addition to the two layers defined above, the filter media medium may have additional layers on one or both sides of the two layers defined above. For example, an additional coform layer could be added adjacent to the first layer, second layer or both. The only requirement if an additional coform layer is added adjacent to the first layer and/or the second layer is that the additional layer must retain the gradient structure for the layers. For example, if an additional coform layer is placed adjacent to the first layer and opposite the second layer and the thermoplastic fiber diameter is smaller than the secondary material, then this additional coform layer must have a lower percentage of the thermoplastic filaments than the first layer. In a similar manner, if an additional coform layer is placed adjacent the second layer and opposite the first layer and the thermoplastic fiber diameter is smaller than the secondary material, the additional layer must have a higher percentage of the thermoplastic filaments than the second layer. It is pointed out that if the secondary material has a smaller fiber diameter, then the percentage of the secondary material must increase or decrease accordingly. More than one additional layer may be placed on either or both sides of the filter medium, provided that the gradient structure is retained.

Other materials may also be laminated to the filter media. Examples include materials which will reinforce the filter medium, materials which improve the filter efficiency and/or materials which improve the aesthetics of the filter medium, including woven materials, nonwoven material, apertured films and the like. The only restriction to additional layers is that the additional layers must not reduce the filter efficiency or the filter capacity. One particularly useful laminate is a lightweight spunbond material having a basis weight of about 0.3 osy (10 gsm) to about 2.0 osy (68 gsm). The spunbond acts to reinforce the coform material of the filter medium and may act as a pre-filtering or post filtering layer. It is preferred, but not required that both layers of the filter medium have a layer of spunbond laminated thereto or formed directly on a spunbond layer.

FIG. 2 illustrates, the present invention as a multilayer filter medium 20 having at least a first layer 22 containing a stabilized matrix of thermoplastic filaments and at least one secondary material; and a second layer 24 having a stabilized matrix of thermoplastic filaments and optionally of at least one secondary material. The second 24 layer is adjacent to the first layer and the weight percentage of the secondary material in the first layer is different from the weight percentage of the secondary material in the second layer. Layer 26 is an additional layer which is optionally laminated to the others. Layer 27 is also an additional layer which is optionally laminated to the other layers. Arrow 28 shows the desired direction in which the particle containing fluid is sent through the filter medium. The additional layers 26 and 27 may be laminated to the first layer 22 and second layers 24 in any manner know to those skilled in the art, so long as that the filter efficiency or filter capacity is not adversely affected by the additional layers.

An additional advantage has been discovered when layer 26 is used in the filter medium. Layer 26 acts as a pre-filter, capturing the largest particle without clogging the filter material. Preferably, layer 26 is a spunbond material. When layer 26 is a spunbond material, the filter material acts as a barrier material until the fluid pressure above the filter material exceeds the barrier pressure. Once the barrier pressure is exceeded by the head of the fluid containing particles, the fluid will flow through the filter medium. This allows for the entire surface of the filter medium of the present invention to be used, instead of a localized section of the filter medium, which in turn also helps improve the overall capacity of the filter medium.

The filter media of the present invention may be prepared by a method including the steps of:

a. providing a first stream of thermoplastic filaments;

b. introducing a stream containing at least one secondary material to the first stream of thermoplastic filaments to form a first composite stream;

c. providing a second stream of thermoplastic filaments;

d. introducing a stream at least one secondary material to the second stream of thermoplastic filaments to form a second composite stream;

e. depositing the first composite stream onto a forming surface as a matrix of thermoplastic filaments and a secondary material to form a first deposited layer; and

f. depositing the second composite stream onto the first deposited layer as a matrix of thermoplastic filaments and a secondary material to form a coform nonwoven web.

One of the first composite stream and the second composite stream has a greater percentage of thermoplastic filaments than the other composite stream. This method sequentially lays down the individual layers of the thermoplastic filaments and at least one secondary. It is noted that it is not critical to the present invention whether the first or second composite stream has the greater percentage of thermoplastic filaments.

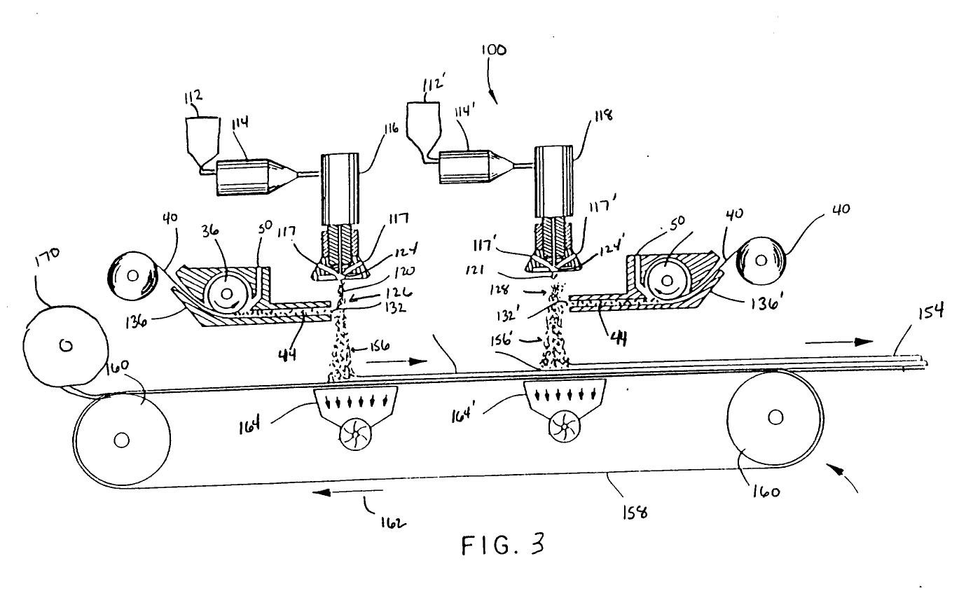

In this regard, attention is directed to FIG. 3, which shows an exemplary apparatus for forming the filter medium of the present invention. The process is generally represented by reference numeral 100. In forming the filter media of the present invention, pellets or chips, etc. (not shown) of a thermoplastic polymer are introduced into a pellet hopper 112, or 112′ of an extruder 114 or 114′, respectively.

The extruders 114 and 114 each have an extrusion screw (not shown), which is driven by a conventional drive motor (not shown). As the polymer advances through the extruders 114 and 114′, due to rotation of the extrusion screw by the drive motor, it is progressively heated to a molten state. Heating the thermoplastic polymer to the molten state may be accomplished in a plurality of discrete steps with its temperature being gradually elevated as it advances through discrete heating zones of the extruders 114 and 114′ toward two meltblowing dies 116 and 118, respectively. The meltblowing dies 116 and 118 may be yet another heating zone where the temperature of the thermoplastic resin is maintained at an elevated level for extrusion.

Each meltblowing die is configured so that two streams of attenuating gas 117 and 117′ per die converge to form a single stream of gas which entrains and attenuates molten threads 120 and 121, as the threads 120 and 121 exit small holes or orifices 124 and 124′, respectively. The molten threads 120 and 121 are formed into filaments or, depending upon the degree of attenuation, microfibers, of a small diameter which is usually less than the diameter of the orifices 124 and 124′. Thus, each meltblowing die 116 and 118 has a corresponding single stream of gas 126 and 128 containing entrained thermoplastic polymer fibers. The gas streams 126 and 128 containing polymer fibers directed toward the forming surface and are generally preferred to be substantially perpendicular to the forming surface.

One or more types of secondary fibers 132 and 132′ and/or particulates are added to the two streams 126 and 128 of thermoplastic polymer fibers 120 and 121, respectively. Introduction of the secondary fibers 132 and 132′ into the two streams 126 and 128 of thermoplastic polymer fibers 120 and 121, respectively, is designed to produce a generally homogenous distribution of secondary fibers 132 and 132′ within streams 126 and 128 of thermoplastic polymer fibers.

Apparatus for accomplishing this merger may include a conventional picker roll 136 and 136′. The picker roll 136 or 136′ has a plurality of teeth 138 that are adapted to separate a mat or batt 140 of secondary fibers into the individual secondary fibers 132. The mat or batt of secondary fibers 140 which is fed to the picker roll 136 or 136′ may be a sheet of pulp fibers (if a two-component mixture of thermoplastic polymer fibers and secondary pulp fibers is desired), a mat of staple fibers (if a two-component mixture of thermoplastic polymer fibers and a secondary staple fibers is desired) or both a sheet of pulp fibers and a mat of staple fibers (if a three-component mixture of thermoplastic polymer fibers, secondary staple fibers and secondary pulp fibers is desired). In embodiments where, for example, an absorbent material is desired, the secondary fibers 132 are absorbent fibers. As is noted above, the secondary fibers 132 may generally be selected from the group including one or more polyester fibers, polyamide fibers, cellulosic derived fibers such as, for example, rayon fibers and wood pulp fibers, multi-component fibers such as, for example, sheath-core multi-component fibers, natural fibers such as silk fibers, wool fibers or cotton fibers or electrically conductive fibers or blends of two or more of such secondary fibers.

The picker rolls 136 and 136′ may be replaced by a conventional particulate injection system to form a coform nonwoven structure 154 containing various secondary particulates. A combination of both secondary particulates and secondary fibers could be added to the thermoplastic polymer fibers prior to formation of the coform nonwoven structure 154 if a conventional particulate injection system was added to the system illustrated in FIG. 3. The particulates may be, for example, charcoal, clay, starches, and/or superabsorbent particles.

Due to the fact that the thermoplastic polymer fibers 120 and 121 are usually still semi-molten and tacky at the time of incorporation of the secondary fibers 132 and 132′ into the thermoplastic polymer fiber streams 126 and 128, the secondary fibers 132 and 132′ are usually not only mechanically entangled within the matrix formed by the thermoplastic polymer fibers 120 or 121′ but are also thermally bonded or joined to the thermoplastic polymer fibers 120 or 121′.

In order to convert the composite stream 156 and 156′ of thermoplastic polymer fibers 120,121 and secondary material 132 and 132′, respectively, into a coform nonwoven structure 154, a collecting device is located in the path of the composite streams 156 and 156′. The collecting device may be an endless belt 158 conventionally driven by rollers 160 and which is rotating as indicated by the arrow 162 in FIG. 3. Other collecting devices are well known to those of skill in the art and may be utilized in place of the endless belt 158. For example, a porous rotating drum arrangement could be utilized. The merged streams of thermoplastic polymer fibers and secondary fibers are collected as a coherent matrix of fibers on the surface of the endless belt 158 to form the coform nonwoven web 154. Vacuum boxes 164 and 164′ assist in retention of the matrix on the surface of the belt 158.

The coform structure 154 is coherent and may be removed from the belt 158 as a self-supporting nonwoven material. Generally speaking, the coform structure has adequate strength and integrity to be used without any post-treatments such as pattern bonding, calendering and the like. However, the structure can be further stabilized by thermally bonding or compressing the coform structure. For example, a pair of pinch rollers or pattern bonding rollers, which may or may not be heated, may be used to bond portions of the material. Although such treatment may improve the integrity of the coform nonwoven web structure 154, it also tends to compress and densify the structure.

The process described above can be modified in a number of different manners without departing from the present invention. For example, additional banks of meltblowing heads and secondary material addition may be added to the process. In addition, the process of the present invention could be carried out in steps using a one bank coform set-up, wherein the first layer is formed and rolled and the second layer is formed onto the unrolled first layer, or visa versa. Further, the coform material may be formed on a previously produced layer, such as a spunbond layer. When a spunbond layer is added to the filter medium, generally it can be produced in-line with the coform material or unwound from a roll onto the collecting device 158 prior to the coform banks. Referring back to FIG. 3, roll 170 supplies the material to the process prior to the first bank of coform. Although not shown in FIG. 3, an additional layer may be unwind from a roll or formed onto the coform material 154 after the second bank of coform.

The characteristics of the meltblown filaments can be adjusted by manipulation of the various process parameters used for each extruder and die head in carrying out the meltblowing process. The following parameters can be adjusted and varied for each extruder and die head in order to change the characteristics of the resulting meltblown filaments:

1. Type of Polymer,

2. Polymer throughput (pounds per inch of die width per hour—PIH),

3. Polymer melt temperature,

4. Air temperature,

5. Air flow (standard cubic feet per minute, SCFM, calibrated for the width of the die head),

6. Distance from between die tip and forming belt and

7. Vacuum under forming belt.

For example, the coarse filaments may be prepared by reducing the primary air temperature from the range of about 600°-640° F. (316°-338° C.) to about 420°-460° F. (216°-238° C.). These changes result in the formation of larger fibers. In cases were larger particle are present in the fluid to be filtered, it may be advantageous to have a first layer having a larger fiber diameter than the second layer. Any other method which is effective in changing the average fiber diameter may also be used and would be in keeping with the invention.

Preparing the coform filter media by the method disclosed above, the amount of secondary material in each layer can be easily varied in the coform nonwoven web. In addition, varying the amount of the secondary material at each layer can help the fluid distribution within the coform nonwoven web by creating a gradient structure for the secondary material

The coform material of the present invention can be prepared on or laminated to an additional material. It is pointed out that this lamination is not required in the present invention. For example, an additional material may be supplied to the process of FIG. 3 before or after the formation of the coform nonwoven filter media. If the material is supplied before the formation of the coform, the coform is formed on the additional material. That is, the additional layer is laid down on the forming surface and the coform is placed on the additional layer. In the alternative, the additional layer may be laminated to the coform of the present invention after the coform is formed. As is noted above, lamination of an additional material to the coform is not required, however, if the secondary material content is greater than about 65-70% by weight in one layer of the coform material, it is preferred that an additional layer be placed onto the coform material to help prevent the secondary material from “linting” out of the coform.

### EXAMPLES

### Example 1

Using the process described in FIG. 3, on a polypropylene spunbond nonwoven fabric having a basis weight of 0.4 osy or 13.6 gsm a first coform layer is formed. The first layer of coform is a fine coform layer comprises 30% by weight pulp (Golden Isles 4824, available from Georgia-Pacific) and 70% by weight polypropylene (PF-015 available from Basell). The polypropylene was meltblown at a rate of about 12.25 pounds per hour, through a die having 30 orifices per inch and having an average orifice diameter of about 0.0145 inches, at a primary air temperature of 500° F., using a primary air flow rates of about 350 cfm (cubic feet per minute) The polypropylene filaments have an average fiber diameter of about 5 microns. A second coform layer comprising 70% by weight pulp (Golden Isles 4824, available from Georgia-Pacific) and 30% by weight polypropylene (PF-015 available from Basell) is then formed on the first coform layer. The polypropylene in the second bank was meltblown at a rate of about 5.25 pounds per hour, through a die having 30 orifices per inch and having an average orifice diameter of about 0.0145 inches, at a primary air temperature of 500° F., using a primary air flow rates of about 325 cfm (cubic feet per minute). The forming surface was moving at a rate of about 181 fpm, resulting coform nonwoven web having a basis weight of about 6.4 osy (217 gsm), including the spunbond layer and any moisture.

### Example 2

The process of Example 1 was repeated, except the forming surface was advanced at a rate of 254 fpm, resulting in a coform nonwoven web having a basis weight of about 4.4 osy (149 gsm), including the spunbond layer and any moisture.

### Example 3

The process of Example 1 was repeated, except the forming surface was advanced at a rate of 340 fpm, resulting in a coform nonwoven web having a basis weight of about 3.4 osy (115 gsm), including the spunbond layer and any moisture.

### Comparative Example 1

Using the process describe in FIG. 2 above, on a polypropylene spunbond nonwoven fabric having a basis weight of 14 gsm a first coform layer is formed. The first coform layer is a fine coform layer comprising 60% by weight pulp (Golden Isles 4824, available from Georgia-Pacific) and 40% by weight polypropylene (PF-015 available from Basell) and has a fine fiber diameter of about 5 micons. The polypropylene was meltblown at a rate of about ten (10) pounds per hour, through a die having 30 orifices per inch and having an average orifice diameter of about 0.0145 inches, at a temperature of 500° F., using a primary air flow rates of about 325 cfm. A second fine meltblown fiber layer of coform comprising 60% by weight pulp (Golden Isles 4824, available from Georgia-Pacific) and 40% by weight polypropylene (PF-015 available from Basell) is then formed on the fine coform layer under the same conditions as the first layer. The forming surface was moving at a rate of about 182 fpm, resulting coform nonwoven fabric has a basis weight of about 6.8 osy (230 gsm), including the spunbond layer and any moisture.

### Comparative Example 2

The process of Comparative Example 1 was repeated, except the forming surface was advanced at a rate of 254 fpm, resulting in a coform nonwoven web having a basis weight of about 4.7 osy (160 gsm), including the spunbond layer and any moisture.

Comparative Example 3

The process of Comparative Example 1 was repeated, except the forming surface was advanced at a rate of 340 fpm, resulting in a coform nonwoven web having a basis weight of about 3.6 osy (122 gsm), including the spunbond layer and any moisture.

The capacity and efficiency of each filter produced in the examples and comparative examples were tested according to the following procedure:

Samples of each coform filter media were cut for each nonwoven fabric produced. Each sample was weighed and the weight was recorded. A sample of the filter media was placed into a filter cartridge and the filter cartridge was sealed. 1 gram of coarse aluminum dust was measured and added to a beaker containing a well stirred mixture of 1200 ml of water heated to 100° F. (37.7° C.) and a coolant QP-24, available from Applied Quality Product, Fontana, Calif. The coolant containing the aluminum dust was then pumped at a rate of about 810 ml per minute to the filter and the discharge from the filter was returned to the beaker in a continuous loop. At five minutes intervals, an additional gram of the aluminum dust is added to the coolant. Coolant was continually passed through the filter until a pressure of 10 psi was reached. Once 10 psi was reached, the time was recorded and the filter media was removed from the filter cartridge.

The filter media was dried in an oven at 200° F. (93.3° C.) for one hour. The dried filter media was then weighed. The difference between the original weight and the used weight is the amount of the aluminum dust captured by the filter media. The efficiency of the filter media is measured dividing the weight of the aluminum captured by the filter media by the amount of aluminum dust added to the coolant. The average results are shown in Table 1 below.

TABLE 1

| | | | | Time to reach a |
|---|---|---|---|---|
| | Total | | % of aluminum | pressure |
| | aluminum | Amount of aluminum | dust removed | increase of |
| Example | dust captured | added to coolant | (efficiency) | 10 psi (Min:sec) |
| 1 | 2.68 | 4.0 | 67.1% | 18:33 |
| Comp. 1 | 1.88 | 3.0 | 62.6% | 10:56 |
| 2 | 2.15 | 3.0 | 71.7% | 14:13 |
| Comp. 2 | 2.07 | 3.0 | 69.1% | 11:12 |
| 3 | 2.72 | 3.0 | 90.8% | 14:18 |
| Comp. 3 | 1.75 | 2.0 | 87.51 | 9.42 |

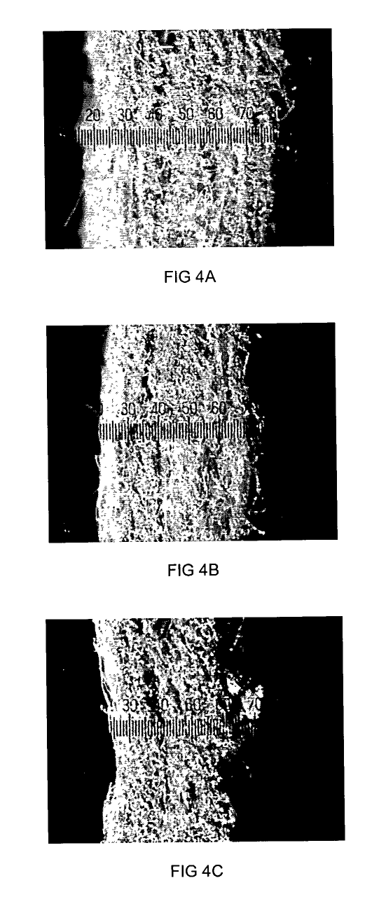

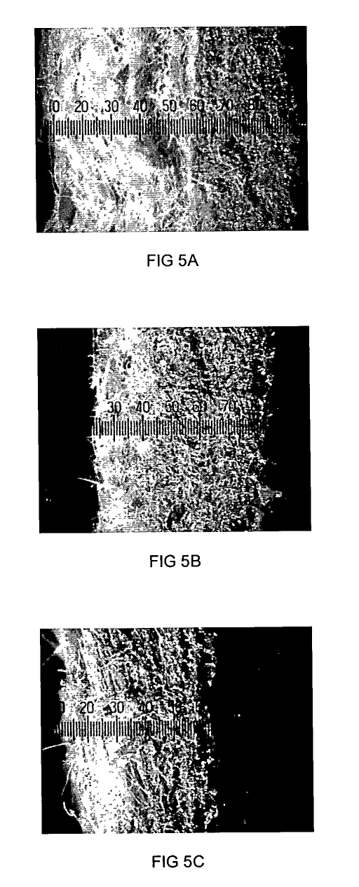

As can be easily seen in Table 1, by creating a gradient of thermoplastic filaments in the filter media, the capacity of the resulting filter is greatly increased while the efficiency of the filter is maintained. In addition, FIGS. 4A-C are micrographs of the filter medium of Examples 1-3, respectively, after the filter has been used in the forgoing test. FIGS. 5A-C are micrographs of the filter medium of Comparative Examples 1-3, respectively, after the comparative filter medium has been used in the forgoing test.

Comparing FIG. 4A to FIG. 5A, FIG. 4B to FIG. 5B and FIG. 4C to FIG. 5C, it can be clearly seen that the filter medium of the present invention better traps the particles in the fluid, than the filter medium without the gradient structure.

In addition, the average pore size and maximum pore size were measured using an Automated Capillary Flow Porometer from PMI Inc., Model No. CFP 1100AEXLH Using a maximum pressure of 75 psi, a maximum flow 150,000 cc/m and the wetting agent Sil-Wick having a surface tension of 20.1 dynes/cm, a 38 mm specimen is placed in the specimen holder. The specimen is placed in reservoir and the top is tightened to retain the specimen in the retaining area. The test is started with a dry run. When dry run is completed, the specimen is immersed in Sil-Wick. The specimen is placed back into the holder, the top is tightened and the wet run is started. The results are reported as the smallest detected pore pressure, the smallest detected pore diameter, the mean flow pore pressure, the mean flow pore diameter, the bubble point pressure, the bubble point pore diameter, the maximum pore size distribution and the diameter at maximum pore size distribution.

The results are shown in Table 2.

TABLE 2

| Sample | Mean Flow Pore Dia. (μm) | Bubble Point Pore Dia. (μm) |
|---|---|---|
| 1 | 14.135 ± 0.817 | 46.379 ± 3.519 |
| Comp. 1 | 13.960 ± 0.839 | 40.183 ± 2.952 |
| 2 | 17.25 ± 1.720 | 49.354 ± 2.268 |
| Comp. 2 | 15.526 ± 2.746 | 51.823 ± 6.497 |
| 3 | 16.868 ± 3.718 | 56.225 ± 13.491 |
| Comp. 3 | 20.850 ± 5.328 | 65.296 ± 10.622 |

As can be seen from Table 2, the average pore size and maximum pore size for the examples of the present invention and the comparative examples are statistically within the averages of each other. Therefore, it would be expected that the filters would have approximately the same characteristics with or without the gradient structure. As can be seen, the gradient structure does not greatly adjust the average pore size for the resulting filter media, but vastly improves the capacity of the filter.

Some additional examples were prepared to show the effect of the having the spunbond layer as a pre-filtering layer before the coform layer.

### Example 4

Using the process described in FIG. 3, on a polypropylene spunbond nonwoven fabric having a basis weight of 0.4 osy or 13.6 gsm a first layer is formed. The first layer is a fine coform layer comprises 60% by weight pulp (Golden Isles 4824, available from Georgia-Pacific) and 40% by weight polypropylene (PF-015 available from Basell) having a basis weight of about 3.0 osy (102 gsm). The polypropylene was meltblown at a rate of about 9.6 pounds per hour, through a die having 30 orifices per inch an having an average orifice diameter of about 0.0145 inches, at a primary air temperature of 500° F., using a primary air flow rates of about 325 cfm (cubic feet per minute). A meltblown layer having a basis weight of about 1.5 osy (51 gsm) comprising 100% by weight polypropylene (PF-015 available from Basell) is then formed on the first layer. The polypropylene in the second bank was meltblown at a rate of about 12 pounds per hour, through a die having 30 orifices per inch an having an average orifice diameter of about 0.0145 inches, at a primary air temperature of 500° F., using a primary air flow rates of about 350 cfm (cubic feet per minute). The forming surface was moving at a rate of about 235 fpm (feet per minute, resulting coform nonwoven web having a basis weight of about 4.9 osy (166 gsm), including the spunbond layer and any moisture.

### Example 5

Using the process described in FIG. 3, on a polypropylene spunbond nonwoven fabric having a basis weight of 0.4 osy or 13.6 gsm a coform layer is formed. The first layer is a fine coform layer comprises 60% by weight pulp (Golden Isles 4824, available from Georgia-Pacific) and 40% by weight polypropylene (PF-015 available from Basell) having a basis weight of about 2.0 osy (68 gsm). The polypropylene was meltblown at a rate of about 9.6 pounds per hour, through a die having 30 orifices per inch an having an average orifice diameter of about 0.0145 inches, at a primary air temperature of 500° F., using a primary air flow rates of about 325 cfm (cubic feet per minute). A meltblown layer having a basis weight of about 1.0 osy (34 gsm) comprising 100% by weight polypropylene (PF-015 available from Basell) is then formed on the first coform layer. The polypropylene in the second bank was meltblown at a rate of about 12 pounds per hour, through a die having 30 orifices per inch an having an average orifice diameter of about 0.0145 inches, at a primary air temperature of 500° F., using a primary air flow rates of about 350 cfm (cubic feet per minute). The forming surface was moving at a rate of about 325 fpm (feet per minute, resulting coform nonwoven web having a basis weight of about 3.4 osy (166 gsm), including the spunbond layer and any moisture.

Two samples of the coform material were taken from each of Examples 4 and 5 and the capacity and efficiency test described above were repeated with the spunbond side of the filter as the first layer of the filter media and the last layer of the filter media.

TABLE 3

| | | % of aluminum dust | Time to reach a pressure |
|---|---|---|---|
| | First Filter | removed | increase of 10 psi |
| Example | Layer | (efficiency) | (Min:sec) |
| 4 | Spun- | 67.4% | >30:00 |
| | bound | | |
| 4 | Meltblown | 95.5% | 2:58 |
| 5 | Spun- | 74.6% | >30:000 |
| | bound | | |
| 5 | Meltblown | 70.0% | 1:12 |

As can be seen by TABLE 3, using the gradient structure in accordance with the present invention, in addition with a spunbond layer as a prefilter layer, increases the life of the filter medium. In addition, the filter medium is usable as a high efficiency filter when the gradient is used in a reverse manner, that is the denser layer is the first layer of the filter medium.

While the invention has been described in detail with respect to specific embodiments thereof, and particularly by the example described herein, it will be apparent to those skilled in the art that various alterations, modifications and other changes may be made without departing from the spirit and scope of the present invention. It is therefore intended that all such modifications, alterations and other changes be encompassed by the claims.

We claim:

1. A filter medium comprising:
a first layer comprising a stabilized matrix comprising thermoplastic filaments and at least one secondary material; and
a second layer adjacent to the first layer comprising a stabilized matrix comprising by weight thermoplastic filaments and optionally of at least one secondary material;
wherein the weight percentage of the secondary material in the first layer, based on the total weight of the thermoplastic filaments and the secondary material in the first layer, is different from the weight percentage of secondary material in the second layer, based on the total weight of the thermoplastic filaments and the secondary material in the second layer.

2. The filter medium of claim 1, wherein the secondary material in the first and second layers comprises cellulose.

3. The filter medium of claim 1,
wherein the first layer has a greater percentage by weight of the secondary material than the second layer.

4. The filter medium according to claim 3, wherein the thermoplastic filaments comprise meltblown filaments.

5. The filter medium according to claim 3, wherein the first layer comprises from about 5% to about 85% by weight of the thermoplastic filaments and from about 15% by weight to about 95% by weight of the secondary material; and a second layer comprises from about 10% to about 100% by weight thermoplastic filaments and from about 0% by weight to about 90% by weight of the secondary material.

6. The filter medium according to claim 5, wherein the first layer comprises from about 20% to about 50% by weight of the thermoplastic filaments and from about 50% by weight to about 80% by weight of the secondary material; and a second layer comprises from about 50% to about 80% by weight thermoplastic filaments and from about 20% by weight to about 50% by weight of the secondary material.

7. The filter medium according to claim 5, wherein the thermoplastic filaments are meltblown filaments.

8. The filter medium according to claim 6, wherein the thermoplastic filaments are meltblown filaments.

9. The filter medium according to claim 1, wherein the at least one secondary material is selected from the group consisting of absorbent fibers, absorbent particles, non-absorbent fibers, non-absorbent particles and mixtures thereof.

10. The filter medium according to claim 9, wherein the at least one secondary material comprises an absorbent fiber or a non-absorbent fiber.

11. The filter medium according to claim 10, wherein the at least one secondary material comprises pulp fibers.

12. The filter medium according to claim 11, wherein the thermoplastic filaments comprise meltblown filaments.

13. The filter medium according to claim 5, wherein the at least one secondary material is selected from the group consisting of absorbent fibers, absorbent particles, non-absorbent fibers, non-absorbent particles and mixture thereof.

14. The filter medium according to claim 13, wherein the at least one secondary material comprises cellulosic fibers.

15. The filter medium according to claim 14, wherein the thermoplastic filaments comprise meltblown filaments.

16. The filter medium according to claim 1, further comprising at least one additional layer adjacent to the first layer or the second layer.

17. The filter medium of claim 16, wherein the additional layer comprises a spunbond nonwoven web.

18. The filter medium of claim 17, wherein the additional layer is adjacent to the first layer, opposite the second layer.

19. The filter medium of claim 17, wherein there are two additional layers, one additional layer is adjacent to the first layer and the other is adjacent the second layer.

20. The filter medium according to claim 5, further comprising at least one additional layer adjacent to the first layer or the second layer.

21. The filter medium of claim 20, wherein the additional layer comprises a spunbond nonwoven web.

22. The filter medium of claim 21, wherein the additional layer is to the first layer, opposite the second layer.

23. The filter medium of claim 21, wherein there are two additional layers, one additional layer is adjacent to the first layer and the other is adjacent the second layer.

24. A method of removing particles from a fluid containing particles, said method comprising contacting the fluid containing particles with the filter medium of claim 1 in a manner such that the fluid containing particles is passed through the first layer of the filter medium before the second layer.

25. A method of removing particles from a fluid containing particles, said method comprising contacting the fluid containing particles with the filter medium of claim 15 in a manner such that the fluid containing particles is passed through the first layer of the filter medium before the second layer.

26. A method of removing particles from a fluid containing particles, said method comprising contacting the fluid containing particles with the filter medium of claim 18 in a manner such that the fluid containing particles is passed through the first layer of the filter medium before the second layer.

27. A method of removing particles from a fluid containing particles, said method comprising contacting the fluid containing particles with the filter medium of claim 22 in a manner such that the fluid containing particles is passed through the first layer of the filter medium before the second layer.
